(19) United States
(12) Patent Application Publication
(10) Pub. No.: US 2024/0408826 A1
(43) Pub. Date: Dec. 12, 2024

(54) HIGH RESOLUTION PRINTING SYSTEM AND A METHOD OF ALIGNING PIXELATED TILES

(71) Applicant: Lung Biotechnology PBC, Silver Spring, MD (US)

(72) Inventors: Akarsh Sivaprasad, Nashua, NH (US); Shaunak Shilimkan, Valley Center, CA (US); Daniel E. Backman, Bedford, NH (US)

(73) Assignee: Lung Biotechnology PBC, Silver Spring, MD (US)

(21) Appl. No.: 18/734,286

(22) Filed: Jun. 5, 2024

Related U.S. Application Data
(60) Provisional application No. 63/471,384, filed on Jun. 6, 2023.

(51) Int. Cl. B29C 64/393; B29C 64/129; B29C 64/232; B29C 64/255; B29C 64/264; B33Y 10/00; B33Y 30/00; B33Y 50/02

(52) U.S. Cl. CPC B29C 64/393; B29C 64/129; B29C 64/232; B29C 64/264; B33Y 10/00; B33Y 30/00; B33Y 50/02; B29C 64/255

(57) ABSTRACT

A three-dimensional (3D) printing apparatus is configured to manufacture a 3D article in a layer-layer manner. The 3D printing apparatus includes a projector configured to selectively irradiate a photosensitive apparatus along a horizontal build plane defined along X and Y axes. The projector is coupled to a lateral movement mechanism configured to laterally scan the projector along X′ and Y′ axial movement coordinates. The X′ and Y′ axial movement coordinates are not exactly aligned with the X and Y axes respectively. For individual layers of the 3D article, the projector is configured to irradiate a sequence of adjacent pixelated tiles within the build plane. Before irradiating the sequence of tiles, the projector is configured to operate a camera and to align leading and trailing edges of the tiles along each of X′ and Y′.

### CROSS-REFERENCE TO RELATED APPLICATIONS

The present application claims priority to U.S. Provisional Application No. 63/471,384, filed Jun. 6, 2023, the entire contents of which are incorporated herein by reference.

### FIELD

The present disclosure concerns an apparatus and method for manufacture of solid three dimensional (3D) articles from photosensitive, such as radiation curable, materials in a layer-by-layer manner. More particularly, the present disclosure concerns an improved high resolution apparatus that cures individual layers using a sequence of pixelated tiles having aligned leading and trailing edges.

### BACKGROUND

Three dimensional (3D) printers are in rapidly increasing use for manufacturing customized articles. One class of 3D printers includes stereolithography printers having a general principle of operation including the selective curing and hardening of photosensitive fluids, such as radiation curable (i.e., photocurable) liquids. One type of stereolithography system includes a containment vessel holding the photosensitive fluid, such as a photocurable liquid, a movement mechanism coupled to a support tray, and a light engine. The stereolithography system forms a three dimensional (3D) article of manufacture by selectively curing layers of the photosensitive fluid, such as a photocurable liquid, along a build plane. There is a desire to produce articles having features sizes that are 10 microns or smaller in size. One challenge is to be able to align very high resolution step and repeat projected image tiles.

### SUMMARY

An aspect of the disclosure includes a method of manufacturing a three-dimensional (3D) article including operating a 3D printing apparatus. The 3D printing apparatus includes a projector configured to selectively irradiate a photosensitive fluid along a horizontal build plane defined along X and Y axes. The projector is coupled to a lateral movement mechanism configured to laterally scan the projector along X′ and Y′ axial movement coordinates. The X′ and Y′ axial movement coordinates are not exactly aligned with the X and Y axes respectively. The projector is configured to irradiate a sequence of adjacent pixelated tiles within the build plane, thereby curing the respective portions of the photosensitive fluid. The method includes (1) providing a camera having a camera field of view (CFV) that is laterally within the build plane, (2) positioning the projector along the X′ and Y′ axial movement coordinates to place a leading edge of a first pixelated tile within the camera field of view, (3) operating the projector to at least illuminate the leading edge of the first pixelated tile, (4) operating the camera to capture the leading edge of the first pixelated tile, (5) translating the projector along Y′ to position a second pixelated tile adjacent to the first pixelated tile and with a trailing edge of the second pixelated tile to align with the leading edge of the first pixelated tile, (6) operating the projector to at least illuminate the trailing edge of the second pixelated tile, (7) operating the camera to capture the trailing edge of the second pixelated tile, (8) computing an alignment error along X′ and along Y′ of the trailing edge with respect to the leading edge, and (9) remapping the X′ and Y′ axial movement coordinates to align the leading edge of the first pixelated tile to the trailing edge of the second pixelated tile.

In one implementation, operating the projector includes projecting the first pixelated tile and the second pixelated tile upward to the build plane. The 3D printing apparatus includes a support surface at least partially laterally surrounding the build plane. Providing the camera includes loading an image capture plate onto the support surface. The image capture plate includes the camera in downward facing orientation.

In another implementation, operating the projector includes projecting the first pixelated tile and the second pixelated tile upward to the build plane. The 3D printing apparatus includes a support surface at least partially laterally surrounding the build plane. The method includes loading a build vessel upon the support surface and loading the photosensitive fluid into the build vessel either before or after loading the build vessel onto the support surface. The 3D printing apparatus includes an elevator coupled to a vertical movement mechanism. The method further comprising loading a build platform onto the elevator. The build platform includes a build plate. The build vessel includes a transparent member that provides a lower bound for the photosensitive fluid. The method further includes operating the vertical movement mechanism, the lateral movement mechanism, and the projector to fabricate the 3D article with a sequence of selectively cured layers formed at the build plane above the transparent member. The method further includes operating the vertical movement mechanism to position a lower face of the build plate or a previous layer of the 3D article at the build plane and operating the lateral movement mechanism and the projector to irradiate a sequence of pixelated tiles over the build plane to selectively irradiate (cure) a layer of the sequence of selectively cured layers, sequential tiles aligning along leading and trailing edges.

### BRIEF DESCRIPTION OF THE FIGURES

FIG. 1 is an isometric drawing of an embodiment of a three-dimensional (3D) printing apparatus.

FIG. 2 is a top view of a portion of an embodiment of a three-dimensional (3D) printing apparatus.

FIG. 3 is a simplified electrical block diagram of an embodiment of a three-dimensional (3D) printing apparatus.

FIG. 4 is a schematic diagram of a build plane over which a sequence of tiles are imaged to form a layer or slice of a 3D article. The tiles are shown as misaligned and overlapping.

FIG. 5 is a schematic diagram depicting a camera field of view (CFW) within a build plane. Two sequential but misaligned tiles are shown within the camera field of view.

FIG. 6 is a schematic diagram that shows the two misaligned tiles from FIG. 5.

FIG. 7 is a schematic diagram showing the tiles from FIG. 6 after they have been aligned along axial movement coordinates X′ and Y′.

FIG. 8 is a flowchart of an embodiment of a method of manufacturing a 3D article.

FIG. 9 is a flowchart of an embodiment of a method for aligning the pixelated imaging tiles.

FIG. 10 is a flowchart of an embodiment of a method for fabricating a 3D article.

### RELATED APPLICATIONS

The following patent documents, each of which is incorporated herein by reference in its entirety, may be useful for understanding this application: U.S. Patent Application Publications Nos: 2022-0370188; 2022-0389374; 2022-0356433; 2022-0371268; 2022-0354954; 2022-0355541; 2022-0055289; PCT Patent Application Publications Nos. WO2022/236030; WO2022/236061; WO2022/236119; WO2022/236116; WO2022/236125; WO2022/236103; WO2022/046719.

### DETAILED DESCRIPTION

Unless otherwise specified, “a” or “an” means “one or more.”

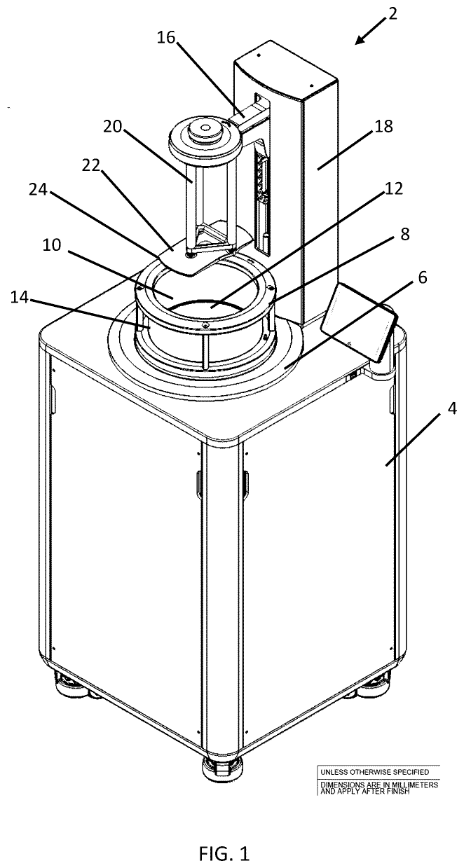

FIG. 1 is an isometric drawing depicting an embodiment of three-dimensional (3D) printing apparatus 2. In describing 3D apparatus 2, mutually perpendicular axes X, Y, and Z will be used. Axes X and Y are generally horizontal lateral axes. Axis Z is a vertical axis that is generally aligned with a gravitational reference. In using the word “generally” it is implied that a limitation that is “generally” true is by design and to within manufacturing tolerances. Additionally angular axes theta-X, theta-Y, and theta-Z are rotations about the X, Y, and Z axes respectively. 3D printing apparatus 2 includes a chassis or housing 4 that supports various components including a support surface 6.

In the illustrated embodiment, a build vessel 8 rests upon the support surface 6. The build vessel 8 is configured to contain a volume or column of a photosensitive fluid 10, such as a photocurable liquid. The build vessel 8 includes a transparent sheet and/or plate 12 that defines a lower bound for the photocurable liquid 10. The build vessel 8 also includes a lateral wall 14 for laterally containing the photocurable liquid 10.

In some embodiments, the photosensitive fluid, such as a photocurable liquid or ink, may be a photosensitive fluid disclosed in one or more of US 2022-0370188, US 2022-0356433, US 2022-355541; US2022-389374; US 2022-0371268; US 2022-0354954, each of which is incorporated by reference in its entirety. In some embodiments, the photosensitive fluid, such as a photocurable liquid or ink, may be a bioink, which may be biocompatible. In some embodiments, the photosensitive fluid, such as a photocurable liquid or ink may be used for printing a 3D model, which may be a bioscaffold, such as the one disclosed in one or more of US 2022-0370188, US 2022-0356433, US 2022-355541; US2022-389374; US 2022-0371268; US 2022-0354954. In some embodiments, the 3D model may be an artificial organ (e.g. lung, liver, kidney, heart, a portion of the heart, etc. or a scaffold for tissue engineering).

An elevator 16 is coupled to a vertical movement mechanism 18. The elevator 16 in turn supports a build platform 20. Build platform 20 includes a build plate 22 having a lower surface or face 24. The lower face 24 supports a 3D article (not shown) that also has a lower face 24 as it is being formed. Element 24 is defined as a lower surface 24 of either the build plate 22 or 3D article during fabrication of the 3D article. The vertical movement mechanism 18 is configured to vertically position the build plate 22 and hence the lower face 24.

An embodiment of vertical movement mechanism 18 includes a motorized ball bearing screw mechanism or otherwise referred to as a ball screw mechanism. A ball screw mechanism includes a vertical screw shaft that passes through a ball nut. The ball nut contains recirculating steel balls and translates vertically. The vertical screw shaft has helical channels that engage the recirculating balls. The elevator 16 includes the ball nut. A motor is coupled to the vertical screw shaft and is configured to selectively rotate the vertical screw shaft. As the vertical screw shaft rotates, the action of the vertical screw shaft upon the ball nut translates the elevator upward and downward depending on a direction of rotation. Such translation mechanisms are known in the art for precision positioning along vertical, horizontal, and oblique axes. Other embodiments are possible such as a lead screw and nut system or a rack and pinion mechanism or a motorized belt/pulley system and are all known in the art for linearly translating components along various axes. All references to movement mechanisms described herein can utilize one or more of these known methods.

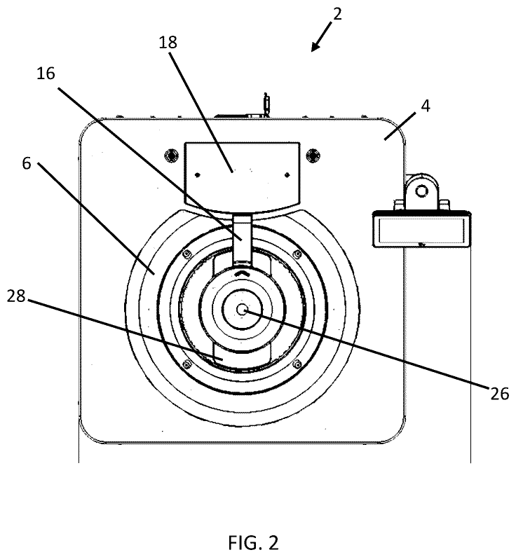

FIG. 2 depicts a top view of a portion of the 3D printing apparatus 2 including some of the elements previously referenced. A projector 26 is coupled to a lateral movement mechanism 28. The lateral movement mechanism 28 is configured to position, scan, and translate the projector 26 along axial movement coordinates or axes X′ and Y′. The axial movement coordinates X′ and Y′ correspond to the lateral axes X and Y. However, X′ and Y′ may not be exactly aligned to X and Y respectively and they may not be exactly orthogonal.

In the illustrated embodiment, the lateral movement mechanism 28 includes a pair of linear motors that drive screw or gear mechanisms that provide translation of the projector 26 along X′ and Y′. In a particular embodiment, the linear motors individually turn lead screws. The lead screws are threaded into nuts of X and Y stages that support the projector 26. Motor rotation therefore translates into linear motion along the axial movement coordinates X′ and Y′.

In the illustrated embodiment, the projector 26 is a projection-based light engine. The projector includes a light source, a spatial light modulator, and projection optics. The light source illuminates the spatial light modulator with electromagnetic radiation having a wavelength which may photocure the photocurable liquid. In some embodiments, such wavelength may be in a blue to ultraviolet range. In some embodiments, the wavelength may be from 200 nm to 500 nm or from 250 nm to 495 nm or from 300 nm to 460 nm or any value or subrange within these ranges. The spatial light modulator may include an array of micromirrors that individually have two states—an ON state at which a small beam of light is transmitted to the projection optics—an OFF state in which the light reaching the micromirror is “dumped” into a light trap and does not reach the projection optics. The projection optics project and focus small beams of light received onto a rectangular build plane that is above the transparent sheet and/or plate (referred also to as a “transparent member”). The term “transparent member” refers to a plate or sheet that is optically transparent, which may mean having an absolute transmission of at least 80% or at least 90% or at least 95% or at least 98% or at least 99%, to the wavelength of the electromagnetic radiation from the light source. In some embodiments, the transparent member may be optically transparent in the blue to ultraviolet wavelength range of radiation. In some embodiments, the transparent optical member may be transparent to the wavelength from 200 nm to 500 nm or from 250 nm to 495 nm or from 300 nm to 460 nm. In some, embodiments the transparent member may include one or more of a flexible polymer sheet, a rigid glass plate, a rigid polymer plate, a rigid quartz plate, and other known materials. The projector 26 may form a rectangular pixelated tile of light upon the build plane.

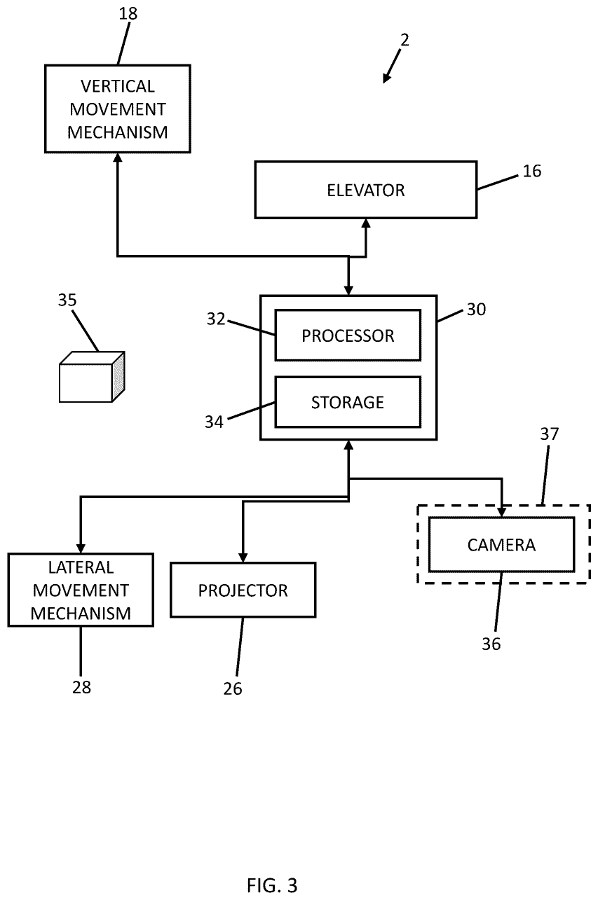

FIG. 3 is a simplified electrical block diagram of the 3D printing apparatus 2. A controller 30 is coupled to various portions of 3D printing apparatus 2 including, inter alia, the elevator 16, the vertical movement mechanism 18, the projector 26, and the lateral movement mechanism 28. Controller 30 includes a processor 32 coupled to an information storage subsystem 34 which includes one or more non-transient or non-volatile storage devices. The information storage 34 stores software instructions that, when executed by the processor 32, operate portions of the 3D printing system 2 including, inter alia, various systems and subsystems shown in FIG. 3. The controller 30 can be a single module co-located with the housing or chassis 4 and/or include modules, computers, and/or servers that are spaced or remote from housing or chassis 4. Controllers including processors and storage subsystems are well known in the art for control of electromechanical systems.

Controller 30 is also coupled to a camera or image capture device 36. Camera 36 can be mounted to an image capture plate 37 that is placed over the support surface 6 with the camera 36 facing downward to receive light from the projector 26 directed upward. Camera 36 is configured to provide information to the controller 30 concerning radiation from projector 26 to be discussed infra. Apparatus 2 is configured to manufacture or fabricate the 3D article 35.

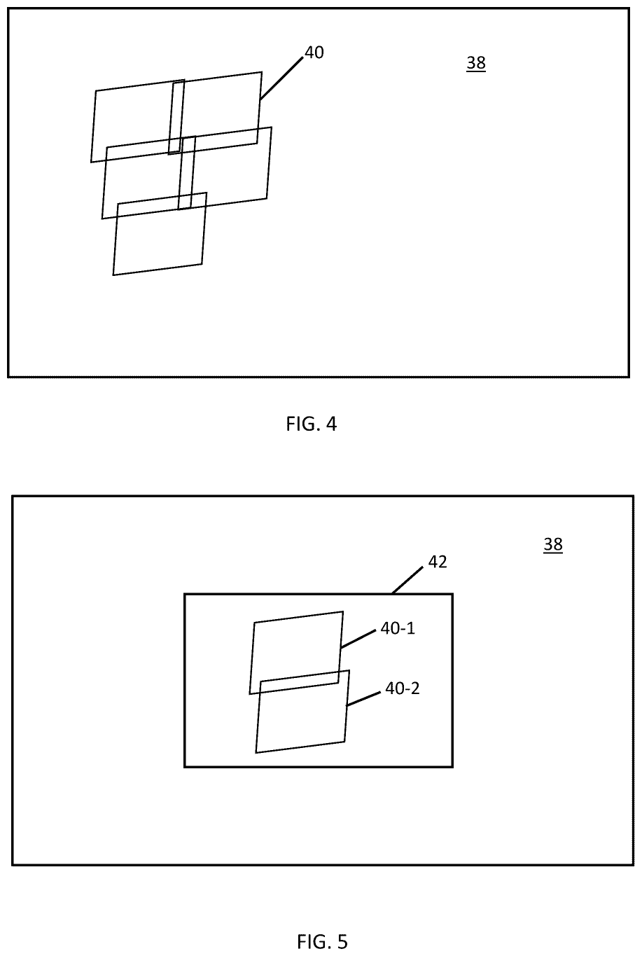

FIG. 4 is a schematic illustration depicting a build plane 38 which is a geometric area over which a light engine or projector 26 operates. The projection optics typically focus on the build plane 38. While illustrated as rectangular, the build plane 38 can be any practical shape including, inter alia, polygonal, circular, oval, asymmetric, or irregular. In one embodiment, the build plane 38 is a circular area that is truncated. But for purposes of explanation, it is shown as rectangular. The build plane may be less than 0.5 millimeter (mm) above the transparent member 12.

As discussed supra, the projector 26 can be translated along each of two dimensions X′ and Y′ by the lateral movement mechanism 28. The axes X′ and Y′ have been described as axial movement coordinates X′ and Y′ that may not be exactly perpendicular to each other. Also, the projector 26 may define a non-rectangular field or tile 40. A pixelated tile 40 is an area over which the projector 26 selectively irradiates the build plane 38.

In order to selectively irradiate an area of the build plane 38, a sequence of tiles 40 are selectively irradiated. In the illustration, the tiles 40 overlap to some extent due to size, shape, and alignment errors. This is undesirable because the areas of overlap are overexposed to radiation. Alternatively, there may be gaps between tiles 40 which would result in uncured underlying photosensitive fluid, such as photocurable liquid, which is also undesirable.

FIG. 5 depicts build plane 38 with a camera field of view (CFV) 42. The camera 36 is configured to focus on the build plane 38 over the lateral camera field of view 42. The camera field of view 42 is a lateral area defined over axes X and Y. Also shown in FIG. 5 are two tiles 40 including a first tile 40-1 and a second tile 40-2 that are sequentially irradiated onto the build plane 38 within the camera field of view 42.

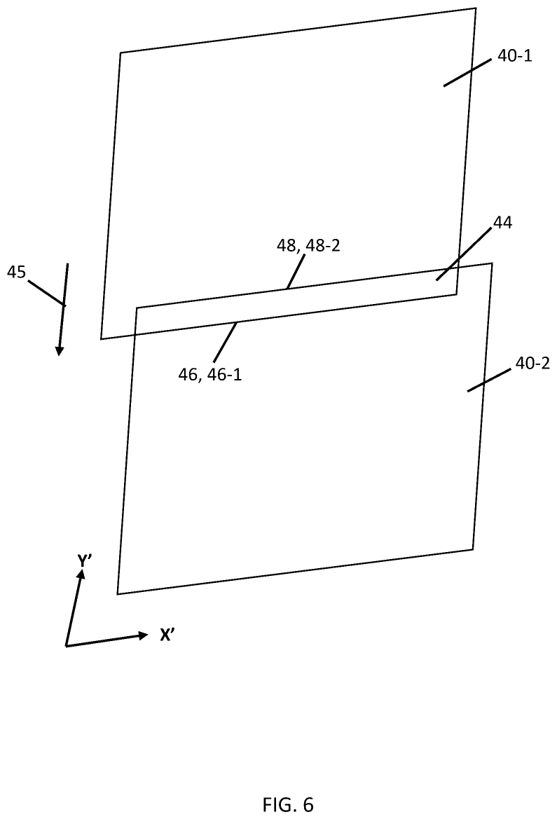

FIG. 6 depicts the first tile 40-1 and a second tile 40-2 in an unaligned state. The unaligned state can be due to the lateral movement mechanism 28 having motor and axial drive mechanisms that are not exactly perpendicular. The unaligned state can also be due to the tile 42 not being perfectly rectangular. The result is a gap or overlap zone 44 between the two tiles.

The arrow 45 indicates the direction 45 of the sequence of illustrated tiles 42. The first tile 40-1 has a leading edge 46 or 46-1 with respect to the sequential direction 45. The second tile 40-2 has a trailing edge 48 or 48-2 with respect to the sequential direction. To avoid zones 44 that are either uncured or overexposed, it is desired to have accurate alignment between the leading edge 46-1 of a first tile 40-1 and a trailing edge 48-2 of a second tile 40-2.

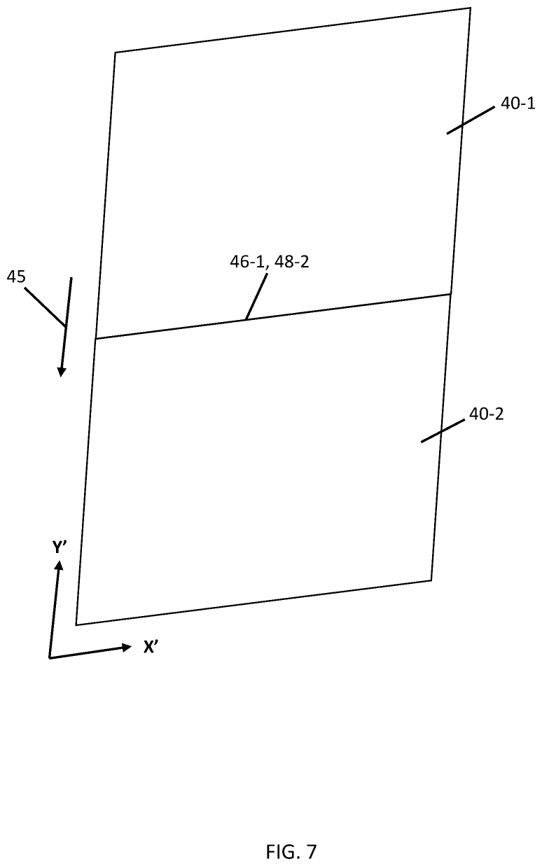

FIG. 7 depicts the first tile 40-1 and second tile 40-2 in an aligned state after remapping coordinates X′ and Y′. In the aligned state, the leading edge 46-1 of the first tile 40-1 is now aligned with the trailing edge 48-2 of the second tile 40-2.

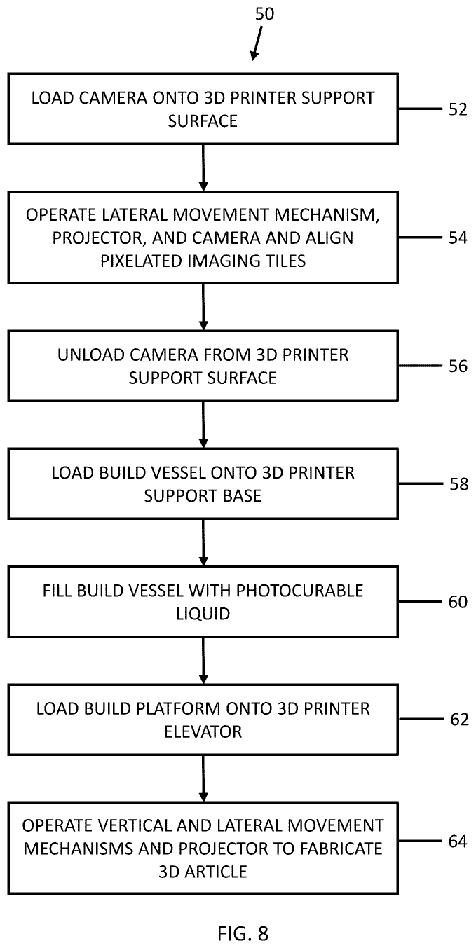

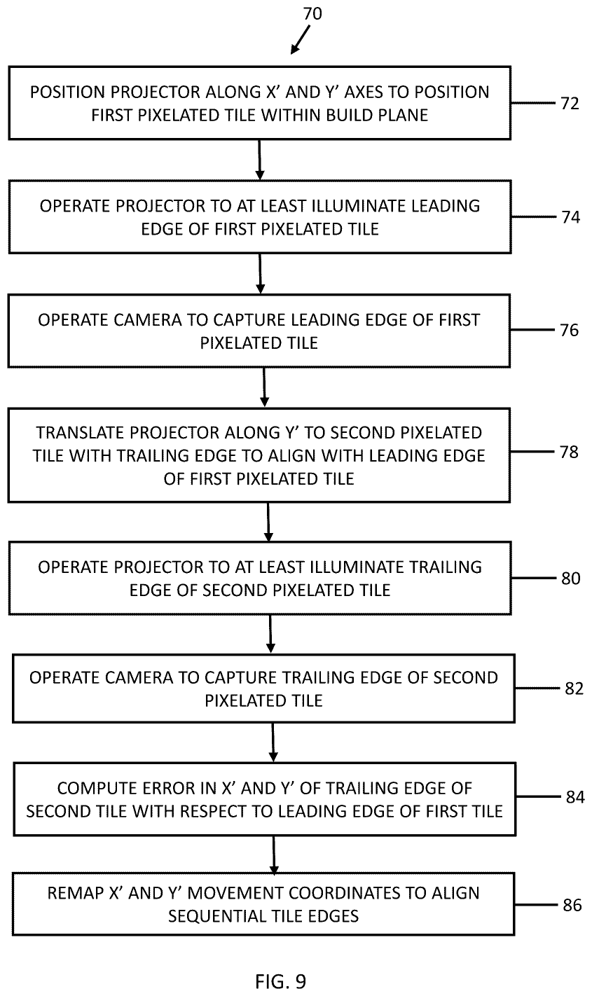

FIG. 8 is a flowchart of an embodiment of a method 50 of manufacturing a 3D article. According to 52, a camera 36 is loaded into 3D printing apparatus 2 by loading an image capture plate 37 upon the support surface 6. According to 54, the controller 30 operates the projector 26, the lateral movement mechanism 28, and the camera 26 to align the pixelated imaging tiles 40. An embodiment of step 54 of method 50 is elaborated on as method 70 of FIG. 9.

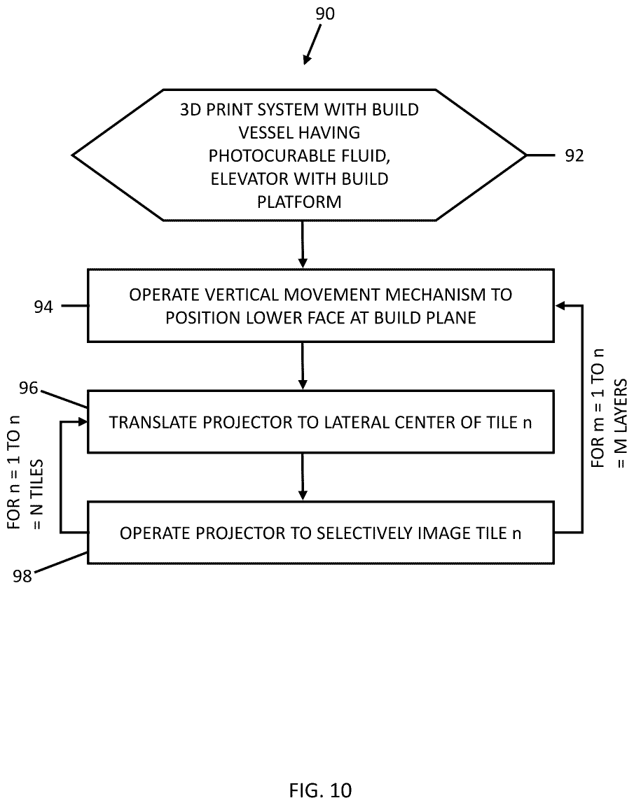

According to 56, the camera 36 is unloaded from the support surface 6. According to 58, the build vessel 8 is loaded onto the support surface 6. According to 60, the build vessel 8 is at least partially filled with photosensitive fluid 10, such as photocurable liquid. According to 62, the build platform 20 is loaded onto the elevator 16. According to 64, the controller 30 operates the vertical movement mechanism 18, the projector 26, and the lateral movement mechanism 28 to fabricate a 3D article. An embodiment of step 64 is elaborated on as method 90 of FIG. 10.

FIG. 9 is a flowchart of an embodiment of a method 70 for aligning the pixelated imaging tiles 40. Method 70 corresponds to step 54 of method 50.

According to 72, the controller 30 operates the lateral movement mechanism 28 to position the projector 26 along the X′ and Y′ axes and to position the first tile 40-1 within the camera field of view (CFV) 42 of the camera 36. According to 74, the controller 30 operates the projector 26 to illuminate part or all of the first pixelated tile 40-1 including at least the leading edge 46-1 within the camera field of view 42. According to 76, the controller 30 operates the camera 36 and captures positional coordinates defined by the leading edge 46-1 of the first tile 40-1.

According to 78, the controller operates the lateral movement mechanism 28 to position the projector along the X′ and Y′ axes and to position the second tile 40-2 within the camera field of view (CVF) 42 of the camera 36. According to 80, the controller 30 operates the projector 26 to illuminate part or all of the second pixelated tile 40-2 including at least the trailing edge 48-2 within the camera field of view 42. According to 82 the controller operates the camera 36 and captures positional coordinates defined by the trailing edge 48-2 of the second tile 40-2.

If there is no error, the leading edge 46-1 of the first tile 40-1 is found to line up perfectly with the trailing edge 48-2 of the second tile 40-2. But in practice, there is a misalignment in both X′ and Y′ between the trailing edge 48-2 and the leading edge 46-1 as depicted in FIG. 6. The controller 30 computes the error in X′ and Y′ of the trailing edge 48-2 with respect to the leading edge 46-1. The controller 30 uses this error to remap the X′ and Y′ movement coordinates to effectively shift the trailing edge 48-2 of the second tile 40-2 to line up in X′ and Y′ with the leading edge 46-1 of the first tile 40-1 as depicted in FIG. 7.

FIG. 10 is a flowchart of an embodiment of a method 90 for fabricating a 3D article using the apparatus 2 that has been calibrated according to method 70. According to 92, the 3D printing apparatus 2 is provided with the build vessel 8 containing photosensitive fluid 10, such as a photocurable liquid or ink, and the build platform 20 loaded upon the elevator 16.

According to 94, the controller 30 operates the vertical movement mechanism 18 to position the lower face 24 of the build plate 22 (or later the 3D article 35) at the build plane 38. According to 96, the controller 30 operates the lateral movement mechanism 28 to position the projector 26 for irradiating the a first tile 40 (n=1). According to 98, the controller 30 operates the projector 26 to selectively irradiate the first tile 40 (n=1). Steps 96 and 98 are repeated for a total of N times to selectively irradiate all of the tiles required for the first slice m=1.

Then the process loops back to step 94 for the second slice m=2. This sequence repeats itself to complete fabrication of the 3D article. Depending upon a geometry of the 3D article, the number N of tiles 40 required for a given slice m may vary. Thus, N may be a function of m or N (m).

The present method and apparatus may allow producing an article having one or more high resolution features. For example, the present method and apparatus may allow producing an article have one or more features having one or more dimensions, such as lateral dimensions, of 10 microns or less, of 8 microns or less, of 6 microns or less, of 5 microns or less, of 4 microns of less, of 3 microns or less, of 2 microns or less, of 1 micron or less, of 0.8 microns or less, or 0.6 microns or less. In some embodiments, the present method and apparatus may allow producing an article have one or more features having each of its lateral dimensions of 10 microns or less, of 8 microns or less, of 6 microns or less, of 5 microns or less, of 4 microns of less, of 3 microns or less, of 2 microns or less, of 1 micron or less, of 0.8 microns or less, or 0.6 microns or less.

In some embodiments, the present method and apparatus may allow producing an article have one or more features having each of its dimensions of 10 microns or less, of 8 microns or less, of 6 microns or less, of 5 microns or less, of 4 microns of less, of 3 microns or less, of 2 microns or less, of 1 micron or less, of 0.8 microns or less, or 0.6 microns or less.

The specific embodiments and applications thereof described above are for illustrative purposes only and do not preclude modifications and variations encompassed by the scope of the following claims.

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

All of the publications, patent applications and patents cited in this specification are incorporated herein by reference in their entirety.

What is claimed:

1. A method of manufacturing a three-dimensional (3D) article including operating a 3D printing apparatus that includes a projector configured to selectively irradiate a photosensitive fluid along a horizontal build plane defined along X and Y axes, the projector coupled to a lateral movement mechanism configured to laterally scan the projector along each of X′ and Y′ axial movement coordinates that are not exactly aligned with the X and Y axes respectively, the projector configured to selectively irradiate a sequence of adjacent pixelated tiles within the build plane, the method comprising:
providing a camera having a camera field of view (CFV) that is laterally within the build plane;
positioning the projector along the X′ and Y′ axial movement coordinates to place a leading edge of a first pixelated tile within the camera field of view;
operating the projector to at least illuminate the leading edge of the first pixelated tile;
operating the camera to capture the leading edge of the first pixelated tile;
translating the projector along Y′ to position a second pixelated tile adjacent to the first pixelated tile and with a trailing edge of the second pixelated tile to align with the leading edge of the first pixelated tile;
operating the projector to at least illuminate the trailing edge of the second pixelated tile;
operating the camera to capture the trailing edge of the second pixelated tile;
computing an alignment error along X′ and along Y′ of the trailing edge with respect to the leading edge; and
remapping the X′ and Y′ axial movement coordinates to align the leading edge of the first pixelated tile to the trailing edge of the second pixelated tile.

2. The method of claim 1, wherein operating the projector includes projecting the first pixelated tile and the second pixelated tile upward to the build plane.

3. The method of claim 2, wherein the 3D printing apparatus includes a support surface at least partially laterally surrounding the build plane, providing the camera includes loading an image capture plate onto the support surface, the image capture plate includes the camera in downward facing orientation.

4. The method of claim 2, wherein the 3D printing apparatus includes a support surface at least partially laterally surrounding the build plane and further comprising loading a build vessel upon the support surface and loading the photosensitive fluid into the build vessel either before or after loading the build vessel onto the support surface.

5. The method of claim 4, wherein the 3D printing apparatus includes an elevator coupled to a vertical movement mechanism, the method further comprising loading a build platform onto the elevator, the build platform includes a build plate.

6. The method of claim 5 wherein the build vessel includes a transparent member that provides a lower bound for the photosensitive fluid and further comprising operating the vertical movement mechanism, the lateral movement mechanism, and the projector to fabricate the 3D article with a sequence of selectively cured layers formed at the build plane above the transparent member.

7. The method of claim 6 wherein, for individual layers of the sequence of selectively cured layers, the method includes:
operating the vertical movement mechanism to position a lower face of the build plate or a previous layer of the 3D article at the build plane; and
operating the lateral movement mechanism and the projector to irradiate a sequence of pixelated tiles over the build plane to selectively cure a layer of the sequence of selectively cured layers, sequential tiles aligning along leading and trailing edges.

8. A 3D printing apparatus comprising:
a photosensitive fluid,
a projector,
a camera,
a lateral movement mechanism, and
a processor,
wherein the projector is configured to selectively irradiate a photosensitive fluid along a horizontal build plane defined along X and Y axes, the projector is coupled to the lateral movement mechanism that is configured to laterally scan the projector along each of X′ and Y′ axial movement coordinates that are not exactly aligned with the X and Y axes respectively, the projector is configured to selectively irradiate a sequence of adjacent pixelated tiles within the build plane, the camera has a camera filed of view that is laterally within the build plane, the processor is configured to control each of the projector, the camera and the lateral movement mechanism,
wherein the apparatus is configured to
position the projector along the X′ and Y′ axial movement coordinates to place a leading edge of a first pixelated tile within the camera field of view;
operate the projector to at least illuminate the leading edge of the first pixelated tile;
operate the camera to capture the leading edge of the first pixelated tile;
translate the projector along Y′ to position a second pixelated tile adjacent to the first pixelated tile and with a trailing edge of the second pixelated tile to align with the leading edge of the first pixelated tile;
operate the projector to at least illuminate the trailing edge of the second pixelated tile;
operate the camera to capture the trailing edge of the second pixelated tile;
compute an alignment error along X′ and along Y′ of the trailing edge with respect to the leading edge; and
remap the X′ and Y′ axial movement coordinates to align the leading edge of the first pixelated tile to the trailing edge of the second pixelated tile.

9. The 3D printing apparatus of claim 8, further configured to project the first pixelated tile and the second pixelated tile upward to the build plane.

10. The 3D printing apparatus of claim 9, further comprising a support surface at least partially laterally surrounding the build plane, an image capture plate on the support surface, wherein the image capture plate includes the camera in downward facing orientation.

11. The 3D printing apparatus of claim 9, further comprising a support surface at least partially laterally surrounding the build plane, a build vessel upon the support surface, the build vessel contains the photosensitive fluid.

12. The 3D printing apparatus of claim 11, further comprising an elevator coupled to a vertical movement mechanism, a build platform on the elevator, the build platform comprises a build plate.

13. The 3D printing apparatus of claim 12, wherein the build vessel includes a transparent member that provides a lower bound for the photosensitive fluid and wherein the apparatus is further configured to operate the vertical movement mechanism, the lateral movement mechanism, and the projector to fabricate the 3D article with a sequence of selectively cured layers formed at the build plane above the transparent member.

14. The 3D printing apparatus of claim 13, wherein, for individual layers of the sequence of selectively cured layers, the apparatus is further configured to
operate the vertical movement mechanism to position a lower face of the build plate or a previous layer of the 3D article at the build plane; and
operate the lateral movement mechanism and the projector to irradiate a sequence of pixelated tiles over the build plane to selectively cure a layer of the sequence of selectively cured layers, sequential tiles aligning along leading and trailing edges.
